(19) United States
(12) Patent Application Publication
(10) Pub. No.: US 2010/0110296 A1
(43) Pub. Date: May 6, 2010

(54) METHOD OF WATCHING DATA BROADCAST AND A RECEIVING DEVICE FOR IMPLEMENTING THE SAME

(75) Inventors: Eun Kyung Shin, Gumi-si (KR); Jae Kyung Lee, Gumi-si (KR)

Correspondence Address: BIRCH STEWART KOLASCH & BIRCH, PO BOX 747, FALLS CHURCH, VA, 22040-0747, US

(73) Assignee: LG ELECTRONICS INC, SEOUL (KR)

(21) Appl. No.: 12/514,195

(22) PCT Filed: Nov. 5, 2007
(86) PCT No.: PCT/KR2007/005554

§ 371 Date: Dec. 29, 2009

(30) Foreign Application Priority Data
Nov. 10, 2006 (KR) 10-2006-0110967

(51) Int. Cl. H04N 5/50; H04N 7/12

(52) U.S. Cl. 348/569; 348/731; 375/240.01; 348/E05.097; 375/E07.076

(57) ABSTRACT

A device for receiving data broadcast signal is disclosed. More specifically, the device includes a memory configured to store data, a primary tuner configured to synchronize at least one transmit stream (TS) of the selected channel, a secondary tuner configured to synchronize each of all available channels in sequential order, a TS processing unit configured to convert the at least one TS into audible audio, displayable video, and displayable data broadcast, a controller configured to determine channels which provide data broadcast from the synchronized channels from the secondary tuner and to store a channel list, which includes channels determined to provide data broadcast, a display module configured to display the channel list on a screen, and at least one speaker configured to output audible audio of the channel.

### TECHNICAL FIELD

The present invention relates to method of watching data broadcast, and more particularly, to method of watching data broadcast and a receiving device for implementing the same.

### BACKGROUND ART

With widespread use and increasing popularity of digital broadcast services, a multi-mode system has been receiving much attention as of late. The multi-mode system allows a user to view broadcast signals of multiple channels via a single digital television broadcast channel.

Compared to conventional broadcast methods through which only video and audio signals are broadcasted, the current or future broadcast systems can include data signal in its broadcast in addition to the video and audio signals. In such systems, receivers are equipped with features and functions to accommodate the changing broadcast systems efficiently and effectively.

Generally, transport stream (TS) for broadcasting of contents are categorized into three (3) types—video signal, audio signal, and data signal.

According to the conventional system, if the user (or a viewer) selects a data broadcast function via a user interface while viewing a broadcast channel, the video and audio corresponding to the selected broadcast (e.g., news, drama) is displayed and outputted, respectively. Moreover, the data broadcast is displayed on the same screen at the same time with the video.

The conventional receiver lacked the function of receiving the data broadcast (or data broadcast signals), and as a result, the data broadcast was received with an aid an external set top box. In displaying the data broadcast, the video (displayed in “1^{st} display area”) corresponding to the broadcast of the data broadcast channel is displayed along with the data (displayed in “2^{nd} display area”) corresponding to the same broadcast channel.

FIG. 1 is a diagram illustrating display of a video corresponding to a broadcast program. FIG. 2 and FIG. 3 are flowcharts illustrating processes associated with viewing a data broadcast. FIG. 4 is a diagram illustrating a layout of a screen when data broadcast is displayed. FIG. 5 is a diagram illustrating a process associated with selecting to view a data broadcast of one channel while viewing a data broadcast of another channel.

Referring to FIG. 2, after a receiver's power is turned on, a controller determines whether a first (or 1^{st}) channel has been selected by a user via a user interface. If it is determined that the first channel has been selected, the controller synchronizes the broadcast signal corresponding to the first channel via a tuner.

Thereafter, the controller displays the video of to the first channel on the entire screen of the display module, and at the same time, outputs audio of the first channel via a speaker or speakers. Here, the video and audio are displayed and outputted, respectively until the power of the receiver is turned off.

Referring to FIG. 3, while the video of the first channel is displayed on the entire screen and the audio of the first channel is outputted via the speaker(s), the controller determines whether a data broadcast key (or button) has been selected on the user interface by the user. If it is determined that the data broadcast key has been selected, the controller displays the video on a first display area of the screen or R1 with respect to FIG. 4. During this time, the audio is continually outputted via the speaker(s). As for the selected data broadcast, the data broadcast of the first channel is then displayed on a second display area (or a different part) of the screen or R2 with respect to FIG. 4. Here, the video and data are displayed in the first display area (e.g., R1) and the second display area (e.g., R2), respectively, until the power of the receiver is turned off.

Referring to FIG. 5, it is possible for a user to wish to view a data broadcast of a different channel while the video and data broadcast of the first channel are displayed in the first display area (e.g., R1) and the second display area (e.g., R2), respectively. If the user selects a different channel (e.g., a second channel), the tuner is operated to synchronize with the broadcast signal of the selected channel or the second channel. Thereafter, the TSs corresponding to the broadcast signals of the second channel (or the selected channel) are then sequentially processed by the structural components.

Further, the controller can determine whether the user has pressed a key or button on the user interface (e.g., remote controller or buttons/keys on the receiver) for the data broadcast. Thereafter, the controller determines whether the data broadcast associated with the second channel is provided or not.

If the data broadcast of the second channel is not provided, the controller displays the video associated with the second channel across the entire screen and outputs the audio of the second channel via the speaker(s). However, if the data broadcast of the second channel is provided, the controller displays the video associated with the second channel in the first display area (e.g., R1) and outputs the audio associated with the second channel via the speakers.

Here, if the first channel is not changed from the first channel to the second channel, the video of the first channel is displayed in the first display area (e.g., R1) and the data broadcast of the first channel is displayed in the second display area (e.g., R2). At the same time, the audio of the first channel is outputted via the speakers. This process continues until the power of the receiver is turned off.

### DISCLOSURE OF THE INVENTION

### Technical Problem

The problems associated with the conventional data broadcast are as follows. First, when the user is viewing the data broadcast of a first channel and the user wishes to view the data broadcast of another channel, the user has to manually go through each channel to determine whether the data broadcast is provided or not for each channel. If the desired channel does not provide the data broadcast, the user has to flip to another channel and determine whether that channel provides the data broadcast. This process continues until a channel with data broadcast service is found, and naturally, this consumes much time.

Second, when a particular broadcast channel is being viewed, the video, audio, and data are related to the particular broadcast channel. That is, the video and the data cannot be independently viewed.

### Technical Solution

Accordingly, the present invention is directed to method of watching data broadcast and a receiving device for implementing the same that substantially obviates one or more problems due to limitations and disadvantages of the related art.

An object of the present invention is to provide a device for receiving data broadcast signal.

Another object of the present invention is to provide a method of displaying data broadcast via a receiver.

A further object of the present invention is to provide a method of displaying data broadcast via a receiving device.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a device for receiving data broadcast signal includes a memory configured to store data, a primary tuner configured to synchronize at least one transmit stream (TS) of the selected channel, a secondary tuner configured to synchronize each of all available channels in sequential order, a TS processing unit configured to convert the at least one TS into audible audio, displayable video, and displayable data broadcast, a controller configured to determine channels which provide data broadcast from the synchronized channels from the secondary tuner and to store a channel list, which includes channels determined to provide data broadcast, a display module configured to display the channel list on a screen, and at least one speaker configured to output audible audio of the channel.

In another aspect of the present invention, a method of displaying data broadcast via a receiver includes synchronizing by a primary tuner at least one transmit stream (TS) of the selected channel, synchronizing by a secondary tuner each of all available channels in sequential order, converting by a TS processing unit the at least one TS into audible audio, displayable video, and displayable data broadcast, determining by a controller at least one channel which provides data broadcast from the synchronized channels from the secondary tuner and storing a channel list, which includes channels determined to provide data broadcast, displaying by a display module the channel list on a screen, and outputting by at least one speaker audible audio of the channel.

In a further aspect of the present invention, a method of displaying data broadcast via a receiving device includes displaying on a screen video associated with the first channel which is selected by a user, determining whether a data broadcast is selected while viewing the video associated with the first channel, if the data broadcast is selected, displaying in a first display area of the screen the video associated with the first channel and in a second display area of the screen the selected data broadcast, and displaying a channel list in a third display area, wherein the channel list includes data broadcast channels, and wherein the channel list is represented in a form of a banner.

It is to be understood that both the foregoing general description and the following detailed description of the present invention are exemplary and explanatory and are intended to provide further explanation of the invention as claimed.

### DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 is a diagram illustrating display of a video corresponding to a broadcast program;

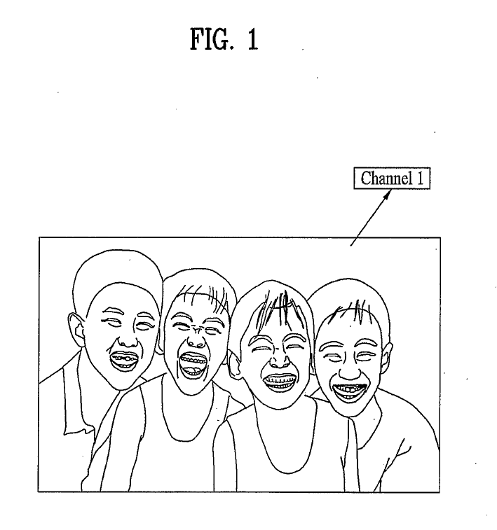

FIG. 2 is a flowchart illustrating processes associated with viewing a data broadcast;

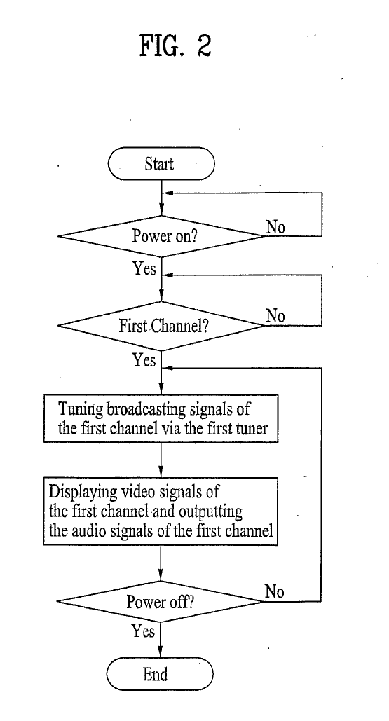

FIG. 3 is another flowchart illustrating processes associated with viewing a data broadcast;

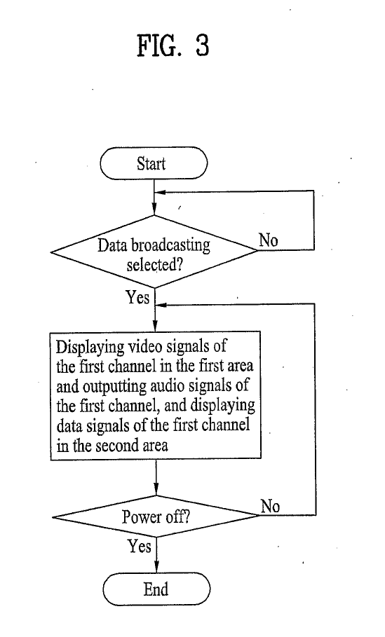

FIG. 4 is a diagram illustrating a layout of a screen when data broadcast is displayed;

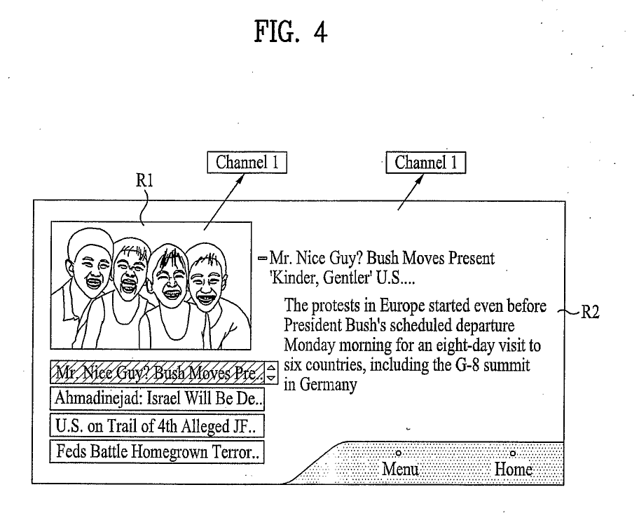

FIG. 5 is a diagram illustrating a process associated with selecting to view a data broadcast of one channel while viewing a data broadcast of another channel;

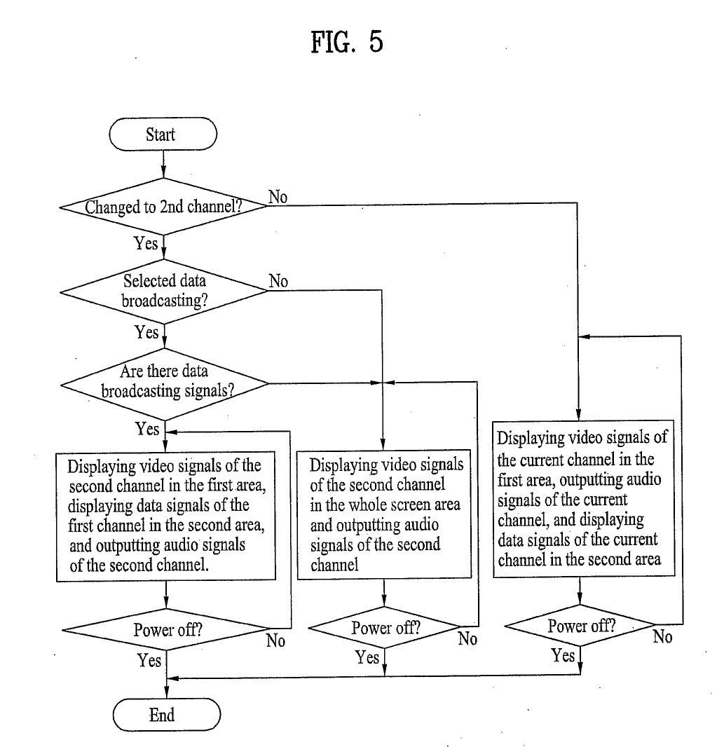

FIG. 6 is an exemplary diagram illustrating a structure of a receiver or a television broadcast receiver;

FIG. 7 is an exemplary flowchart illustrating the processes associated with viewing of data broadcast;

FIG. 8 is another exemplary flowchart illustrating the processes associated with viewing of data broadcast; and

FIG. 9 is an exemplary diagram illustrating a display of a banner including a channel list of available data broadcast(s).

### BEST MODE FOR CARRYING OUT THE INVENTION

Reference will now be made in detail to the preferred embodiments of the present invention, examples of which are illustrated in the accompanying drawings. Wherever possible, the same reference numbers will be used throughout the drawings to refer to the same or like parts.

Hereinafter, data broadcast (or data broadcast signal), other than the video and audio (or video/audio signals), will be referred to as data (or data signal).

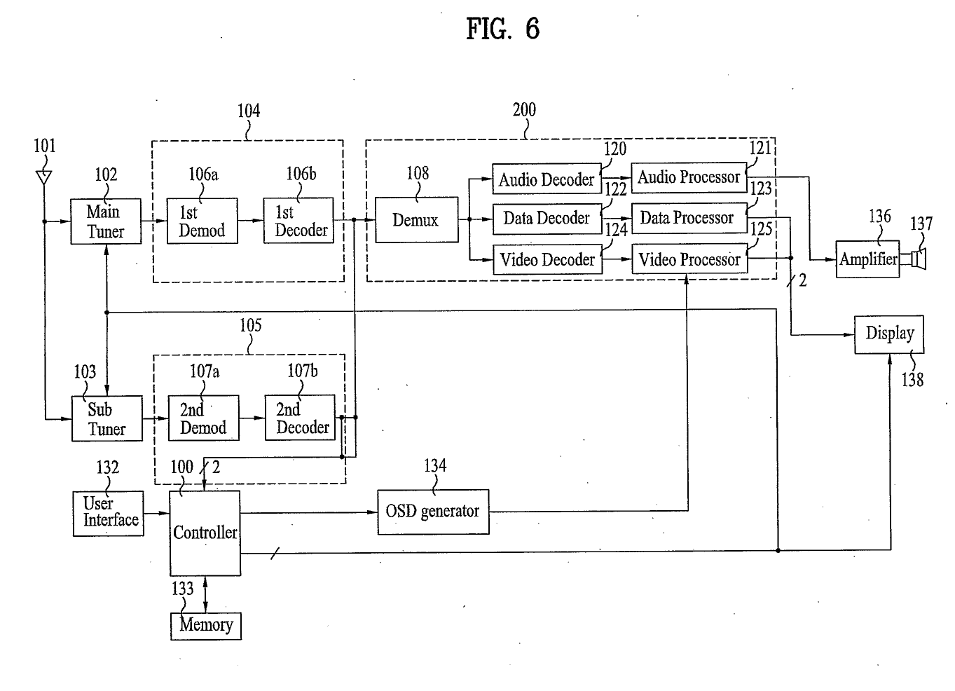

FIG. 6 is an exemplary diagram illustrating a structure of a receiver or a television broadcast receiver. Referring to FIG. 6, the receiver or the television broadcast receiver comprises a controller 100, a memory 133, a user interface 132, an on screen display (OSD) generator 134, an antenna 101, a tuner 101, a digital broadcast processing unit 104, a broadcast signal output unit 200, an amplifier 136, a speaker 137, and a display module 138.

More specifically, the OSD generator 134 can be configured to generate data under the control of the controller 100, the antenna (or antennas) 101 can be configured to receive broadcast signals. Furthermore, a primary tuner 102 can be configured to tune the broadcast signals for viewing, and a secondary tuner 103 can be configured to filter or screen digital channels to find channels which provide data broadcast.

In addition, a first digital broadcast processing unit 104 can be configured to process the TS outputted from the primary tuner 102, and a second digital broadcast processing unit 105 configured to process the digital broadcast signal outputted from the secondary tuner 103. Thereafter, the broadcast signal output unit 200 can be configured to separate the output signals from the first digital broadcast processing unit 104 into the video stream (or signal), data stream (or signal), and audio stream (or signal) for video or data and then convert the signals into a displayable video, audio, and data signals.

Moreover, the receiver further comprises an amplifier 136 configured to amplify audio outputted from the broadcast signal output unit 200. The speaker (or speakers) 137 can be configured to output the amplified audio signal outputted from the amplifier 136 as audible signal. Lastly, the display module 138 can be configured to display the video and/or data outputted from the broadcast signal output unit 200 on a screen.

Here, the number of units of the receiver (e.g., tuner, speaker, and antenna) is not limited to a single unit but can be configured by a plurality of units. For example, the tuner 102 is not limited to a single tuner, but the receiver can be comprised of more than one tuner.

Although the discussions as related to the embodiments of the present invention relate to a receiver or a television broadcast receiver, the discussions are not limited to the aforementioned types of receivers but can be further applied to a different types of receivers, such as a set-top box.

The controller 100 can be configured to control the general/overall operations of the receiver (or the television broadcast receiver). In particular, the controller 100 can be configured to allow operation of the primary tuner 102 to synchronize the broadcast signal of the desired channel according to the data broadcast channel selection. Moreover, the controller 100 can be configured to provide a switching control signal to allow selection of either the audio for the video or the audio for the data based on the user selection.

In addition, the controller 100 can be configured to have the OSD generator 134 generate data for the OSD (also referred to as “OSD data”) corresponding to the selection made by the user. Moreover, the controller 100 can be configured to process the synchronized broadcast signal from the secondary tuner 103 through the second digital broadcast signal processor 105 and categorize the processed signal into a video stream, an audio stream, or a data stream. The controller 100 can then determine whether data broadcast is provided from the selected channel by using these categorized streams.

Further, the memory 133 can be configured to store channel information as information associated with a list for banner configuration if the data broadcast is provided from each synchronized channel. If the user wishes to view the list, the controller 100 can display the list on the screen, and the user can view the list of all channels which provide the data broadcast while viewing a data broadcast of a specified channel. The controller 100 can be configured to repeat the above processes during specified time intervals and updates the list at the same time. The process associated with the list can be provided by the two tuners (e.g., the primary tuner and the secondary tuner).

The memory 133 can be configured to store various information including system program of the controller 100. More specifically, the memory 133 can be configured to store a channel list. Here, the channel list can include channels which provide updated data broadcast. The memory 133 can further be configured to send the stored channel list to the display module 138 upon request/command from the controller 100.

The user interface 132 can be configured to provide various commands/signals inputted via devices or means, such as a remote controller or a keypad, to the controller 100. As discussed, the OSD generator 134 can be configured to generate OSD data and send the generated OSD data to the broadcast signal output unit 200.

The primary tuner 102 and the secondary tuner 103 each can be configured to tune (or synchronize) a broadcast channel from multiple broadcast signals received in TS form, and the TS of the tuned broadcast channel can then be provided to the corresponding first digital broadcast signal processor 104 or the digital broadcast signal processor 105.

The first digital broadcast signal processor 104 can be configured to include a first demodulator 106a and a first decoder 106b. The first demodulator 106a can be configured to demodulate the TS provided by the primary tuner 102, and the first decoder 106b can be configured to decode and convert the demodulated TS into a video stream, an audio stream, and a data stream before providing the converted streams to the broadcast signal output unit 200.

In addition, the second digital broadcast signal processor 105 can be configured to include a second demodulator 107a and a second decoder 107b. The second demodulator 107a can be configured to demodulate the TS provided by the secondary tuner 103, and the second decoder 107b can be configured to decode and convert the demodulated TS into a video stream, an audio stream, and a data stream before providing the converted streams to the controller 100.

The broadcast signal output unit 200 comprises a first demultiplexer 108, an audio decoder 120, an audio processor 121, a data decoder 122, a data processor 123, a video decoder 124, and a video processor 125.

In detail, the demultiplexer 108 can be configured to separate (or demultiplex) the audio, video, and data streams (or signals) outputted from the digital broadcast signal processor 104. The audio decoder 120 can be configured to decode the audio stream (or signals) demultiplexed by the demultiplexer 108. The decoded audio signal can then be converted into audible audio signal by the audio processor 121.

In addition, the data decoder 122 can be configured to decode the data stream (or signals) demultiplexed by the demultiplexer 108. The data processor 123 can then be configured to decode the decoded data signal into a data than can be displayed. Lastly, the video decoder 124 can be configured to decode the video stream (or signals) demultiplexed by the demultiplexer 108. The decoded video signal can then be converted into video signal that can be displayed by the video processor 125.

The OSD generator 134 can be configured to provide the generated OSD data to the video processor 125 of the broadcast signal output unit 200 so that the provided OSD data can be combined with each video and displayed on the screen. If the user desires to view the list at this time, the OSD generator 134 can generate OSD data corresponding to the banner having the list and send it to the video processor 125. Moreover, the user can request for the channel list to be displayed using the user interface 132 and/or an OSD menu.

The display module 138 can be configured to include a liquid crystal display (LCD) module, a plasma display panel (PDP) module, a cathode ray tube (CRT) module, an organic light emitting display (OLED), and a light emitting display (LED), among other modules.

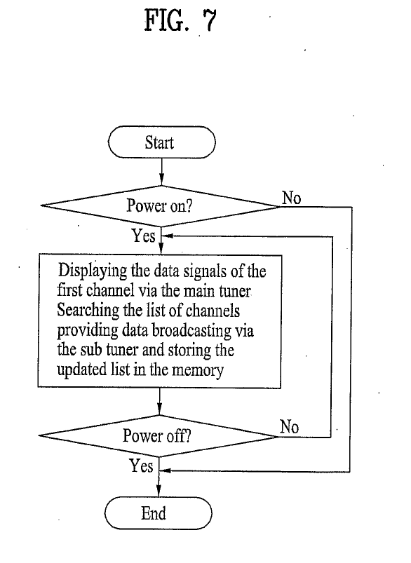

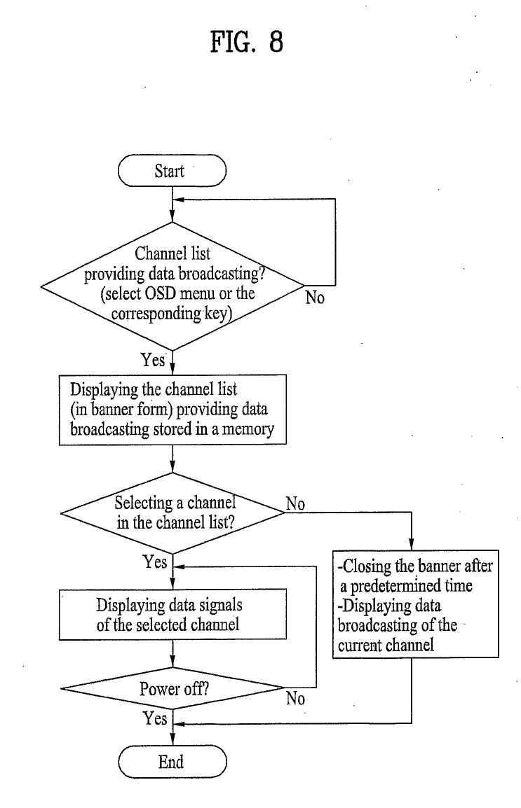

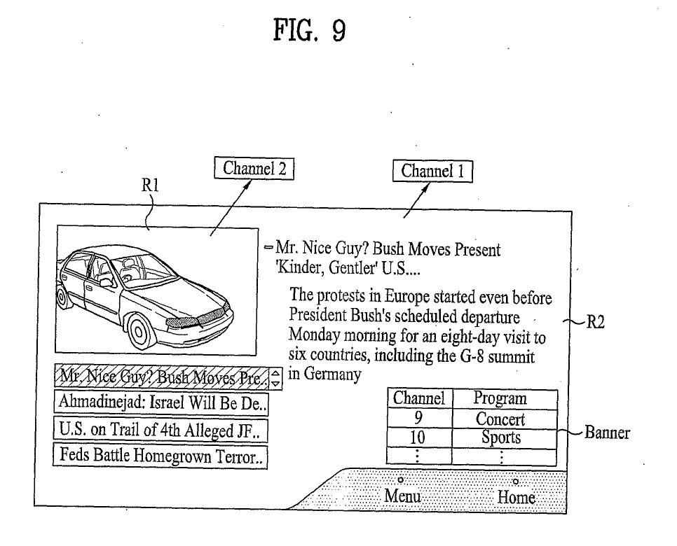

FIG. 7 and FIG. 8 are flowcharts illustrating the processes associated with viewing of data broadcast. FIG. 9 is an exemplary diagram illustrating a display of a banner including a channel list of available data broadcast(s).

Referring to FIG. 7, after the user turns on the power, the controller 100 can determine whether a first channel has been selected by the user via the user interface 132. If it is determined that the user has selected the first channel, the controller 100 can synchronize the broadcast signal corresponding to the selected first channel through the primary tuner 102. Thereafter, the controller 100 can display the video of the first channel on the entire screen of the display module 138 and can output the audio associated with the first channel via the speaker 137.

At this time, if the user chooses to view the channel list which provide data broadcast by inputting the selection via the user interface 132 or the OSD menu feature, the controller 100 sends the signal to display the video of the first channel in a first display area of the screen and to display the data of the first channel in a second display area of the screen. Here, the first display area and the second display area refer to different regions of the screen. For example, the left side of the screen can be dedicated to the first display area while the right side (or the remaining area) can be dedicated to the second display area. It is, however, possible for the display areas to partially overlap each other.

At the same time, the controller 100 sends the signal to display the channel list (or list of channels) which provides the data broadcast channels, stored in the memory 133, in a form of a banner, as illustrated in FIG. 9, in a third display area. Here, the third display area is different from the first and the second display areas. It is possible, however, that the third display area may overlap, in part, with the first display area and/or the second display area.

The controller 100 can then synchronize the channels sequentially with the secondary tuner 103 and synchronize with the corresponding the broadcast signal. Thereafter, the controller 100 determines whether the synchronized channel provides data broadcast or not and stores the channel information of the channels which provide data broadcast in the memory 133. Here, the channel information can be stored in a list format. The controller 100 can be configured to repeat the above processes during specified time intervals (or periodically) and updates the list.

Further, the controller 100 can be configured to ascertain whether the user has selected a channel (hereinafter referred to as “a second channel”) from the channel list displayed in a banner format. If the second channel has been selected by the user, the controller 100 sends the proper signal to the primary tuner 102 to change from the current channel (e.g., the first channel) to the selected channel (or the second channel). Moreover, the controller 100 can send the signal to the primary tuner 102 to display the data broadcast which corresponds to the second channel.

If the second channel is not selected by the user, the controller 100 continues to display the channel list in a banner format on the screen for a specified period of time before ceasing to display it. If the user fails to make a selection of a channel from the channel list during the specified period of time, the controller 100 continues to display the data broadcast of the current channel (e.g., the first channel) until the power of the receiver is turned off. While the selection is contemplated by the user and/or during the specified period of time, the audio corresponding to the first channel is being outputted via the speaker(s) 137.

Lastly, as discussed, the user interface 132 can be a remote controller and/or key input/buttons provided on the receiver.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. A device for receiving data broadcast signal, comprising:
a memory configured to store data;
a primary tuner configured to synchronize at least one transmit stream (TS) of the selected channel;
a secondary tuner configured to synchronize each of all available channels in sequential order;
a TS processing unit configured to convert the at least one TS into audible audio, displayable video, and displayable data broadcast;
a controller configured to determine channels which provide data broadcast from the synchronized channels from the secondary tuner and to store a channel list, which includes channels determined to provide data broadcast;
a display module configured to display the channel list on a screen; and
at least one speaker configured to output audible audio of the channel.

2. The method of claim 1, further comprising an on screen display (OSD) generator configured to generate OSD data in a form of a channel list.

3. The method of claim 2, wherein the channel list is in a form of a banner.

4. The method of claim 1, wherein the TS processing unit includes a broadcast signal output unit which is configured to convert and output a video stream and a data stream into a displayable video and data.

5. The method of claim 4, wherein the broadcast signal output unit includes:
a first digital broadcast signal unit configured to convert the TS outputted from the primary tuner into the video stream, the data stream, and an audio stream;
a second digital broadcast signal unit configured to convert TS outputted from the secondary tuner into the video stream, the data stream, and the audio stream; and
an audio unit configured to convert and output the audio stream into an audio signal.

6. The method of claim 5, wherein each of the first digital broadcast signal unit and the second digital broadcast signal unit includes a demultiplexer for demultiplexing and a decoder for decoding the demultiplexed signals and converting into the video stream, data stream, and the audio stream.

7. The method of claim 4, wherein the broadcast signal output unit includes:
an audio decoder for decoding the audio stream;
a data decoder for decoding the data stream;
a video decoder for decoding the video stream;
an audio processor for converting the decoded audio stream into audible audio;
a data processor for converting the decoded data stream into a displayable data; and
a video processor for converting the decoded video stream into a displayable video.

8. A method of displaying data broadcast via a receiver, the method comprising:
synchronizing by a primary tuner at least one transmit stream (TS) of the selected channel;
synchronizing by a secondary tuner each of all available channels in sequential order;
converting by a TS processing unit the at least one TS into audible audio, displayable video, and displayable data broadcast;
determining by a controller at least one channel which provides data broadcast from the synchronized channels from the secondary tuner and storing a channel list, which includes channels determined to provide data broadcast;
displaying by a display module the channel list on a screen; and
outputting by at least one speaker audible audio of the channel.

9. The method of claim 8, wherein the channel list is in a form of a banner.

10. The method of claim 8, wherein the channel list is displayed for a specified period of time and disappears after the specified time period expires, absent user's input.

11. The method of claim 8, wherein the channel list is controlled via at least one of a user interface and on-screen display menu.

12. The method of claim 8, wherein the video, the data broadcast, and the channel list are displayed, without overlapping each other, on different parts of the screen.

13. The method of claim 8, wherein the channel list is updated periodically by the secondary tuner.

14. The method of claim 8, further comprising:
determining whether a user has selected a different channel from the channel list; and
if the different channel is selected, synchronizing the selected channel with the primary tuner.

15. A method of displaying data broadcast via a receiving device, the method comprising:
displaying on a screen video associated with the first channel which is selected by a user;
determining whether a data broadcast is selected while viewing the video associated with the first channel;
if the data broadcast is selected, displaying in a first display area of the screen the video associated with the first channel and in a second display area of the screen the selected data broadcast; and
displaying a channel list in a third display area, wherein the channel list includes data broadcast channels, and wherein the channel list is represented in a form of a banner.

16. The method of claim 15, wherein the receiving device is a television broadcast receiver.

17. The method of claim 15, wherein the data broadcast is selected via at least one of a user interface and an on-screen display menu.

18. The method of claim 15, wherein the first display area, the second display area, and the third display area are non-overlapping with each other.

19. The method of claim 15, wherein at least one of the first display area, the second display area, and the third display area are partially overlapping with each other.

20. The method of claim 15, further comprising:
(1) synchronizing sequentially channels with corresponding broadcast signals;
(2) determining whether the synchronized channels provide data broadcasting; and
(3) storing information of the channels which provide data broadcasting.

21. The method of claim 20, wherein the steps (1), (2), and (3) are repeatedly performed periodically.

22. The method of claim 15, further comprising:
determining whether a second channel is selected from the channel list while viewing the first channel;
displaying the data of the second channel if the second channel is selected; and
displaying the channel list for a specified period of time, along with the data of the first channel, if the second channel is not selected.
